(19) United States
(12) Patent Application Publication
(10) Pub. No.: US 2025/0117728 A1
(43) Pub. Date: Apr. 10, 2025

(54) OPERATION LOG PROCESSING DEVICE, OPERATION LOG PROCESSING METHOD, AND OPERATION LOG PROCESSING PROGRAM

(71) Applicant: Nippon Telegraph and Telephone Corporation, Tokyo (JP)

(72) Inventors: Fumihiro YOKOSE, Musashino-shi, Tokyo (JP); Kimio TSUCHIKAWA, Musashino-shi, Tokyo (JP); Taisuke WAKASUGI, Musashino-shi, Tokyo (JP); Yuki URABE, Musashino-shi, Tokyo (JP); Ryo UCHIDA, Musashino-shi, Tokyo (JP); Haruo OISHI, Musashino-shi, Tokyo (JP)

(21) Appl. No.: 18/730,025

(22) PCT Filed: Jan. 26, 2022
(86) PCT No.: PCT/JP2022/002956

§ 371 Date: Jul. 18, 2024

(51) Int. Cl. G06Q 10/0633

(52) U.S. Cl. CPC G06Q 10/0633

(57) ABSTRACT

In a case where an input of an operation log indicating a series of operations to a computer is received, an operation log processing device detects an operation log of a rework operation that is an operation log to the same operation position from operation logs. Thereafter, the operation log processing device displays the detected operation log of the rework operation among the operation logs indicating the series of operations to distinguish the detected operation log from other operation logs or removes the operation log of the rework operation, and creates information visualizing a process of the series of operations. In addition, the operation log processing device outputs the created information.

### TECHNICAL FIELD

The present invention relates to an operation log processing device, an operation log processing method, and an operation log processing program.

### BACKGROUND ART

In the related art, in order to improve business using a PC, there is a process mining technique for acquiring an operation log on the PC and analyzing a flow (process) of operations of the business.

### CITATION LIST

### Non Patent Literature

Non Patent Literature 1: NTT Technical Journal, “DX sokushin ni koken suru gyomu kashika gijutsu (in Japanese) (Business visualization technology contributing to DX promotion)”, [online], [Retrieved Jan. 17, 2022], the Internet <URL: https://journal.ntt.co.jp/wp-content/uploads/2020/05/JN20200272.pdf>

### SUMMARY OF INVENTION

### Technical Problem

However, in a case where the operation log is directly subjected to process mining, rework or the like due to an operation error is also directly analyzed. In this process mining, in a case where it is desired to clarify a standard operation flow or the like, rework due to an operation error needs to be distinguished because the rework due to an operation error is not an element to be focused on in the analysis. However, a portion to be focused on and a rework operation are mixed and visualized, and as a result, there is a problem that it takes time and effort to proceed with the analysis. Therefore, an object of the present invention is to solve the above-described problem and to make it easy to distinguish a rework operation and other operations in process mining.

### Solution to Problem

In order to solve the problems described above, the present invention includes an operation log processing device including: a reception unit that receives an input of an operation log indicating a series of operations to a computer; a detection unit that detects an operation log of a rework operation from operation logs indicating the series of operations; and an information creation unit that displays the detected operation log of the rework operation among the operation logs indicating the series of operations to distinguish the detected operation log from other operation logs or removes the operation log of the rework operation, and creates information visualizing a process of the series of operations.

### Advantageous Effects of Invention

According to the present invention, it becomes easy to distinguish a rework operation and other operations in process mining.

### BRIEF DESCRIPTION OF DRAWINGS

FIG. 1 is a diagram illustrating an outline of an operation log processing device.

FIG. 2 is a diagram illustrating an outline of an operation log processing device.

FIG. 3 is a diagram illustrating an example of a rework operation in a series of operations on a web page.

FIG. 4 is a diagram illustrating a configuration example of the operation log processing device.

FIG. 5 is a diagram illustrating an example of original data of an operation log.

FIG. 6 is a diagram illustrating an example of an operation log including an operation ID.

FIG. 7 is a diagram illustrating an example of an operation log including a page ID and an operation ID.

FIG. 8 is a diagram illustrating an example of an operation log to which a duplication flag is assigned.

FIG. 9 is a diagram illustrating an example of a graph specifying a rework operation included in an operation log.

FIG. 10 is a diagram illustrating an example of a graph from which a rework operation included in an operation log is deleted.

FIG. 11 is a diagram illustrating an example of aggregation of graphs specifying a rework operation.

FIG. 12 is a diagram illustrating an example of aggregation of graphs from which a rework operation is deleted.

FIG. 13 is a flowchart illustrating an example of a processing procedure of the operation log processing device.

FIG. 14 is a diagram illustrating a configuration example of a computer that executes an operation log processing program.

### DESCRIPTION OF EMBODIMENTS

Hereinafter, a mode (embodiment) for carrying out the present invention will be described with reference to the drawings. The present invention is not limited to the embodiment to be described below.

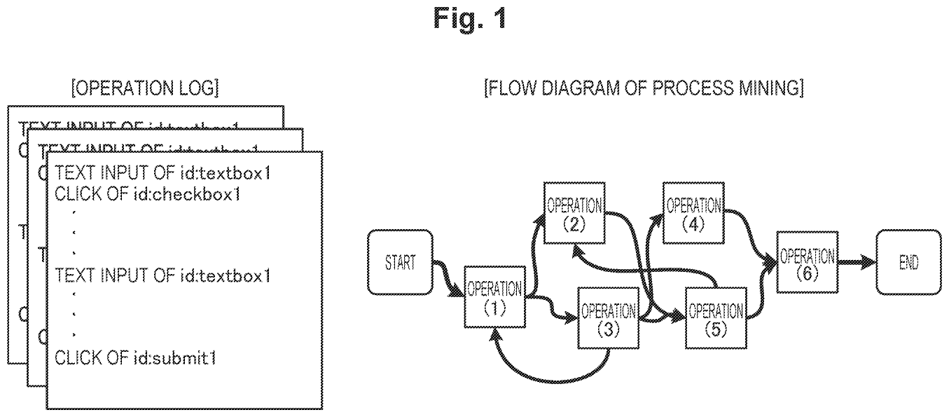

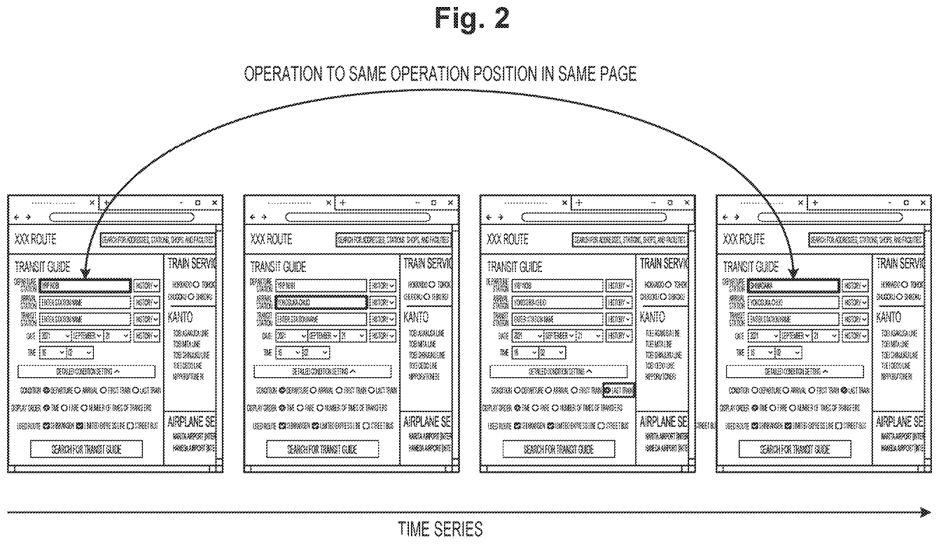

First, an outline of an operation log processing device of the present embodiment will be described with reference to FIG. 1 to FIG. 3. For example, as illustrated in FIG. 1, the operation log processing device receives an input of an operation log indicating a series of operations to a computer. This operation log is, for example, information describing an operation date and time, an operation page, an operation position, and the like in a series of operations (refer to FIG. 2) performed on a web page by a user of the computer.

The operation log processing device performs process mining on the input operation log, and creates a flow diagram illustrating an operation procedure of the computer.

For example, as illustrated in FIG. 1, the flow diagram visualizes a series of operations indicated by an operation log by a directed graph using nodes and edges. The operation log processing device performs process mining on an input operation log, and creates the flow diagram illustrated in FIG. 1 by, for example, aggregating nodes of the same operation and aggregating edges between the same nodes.

Here, in a case where the operation log includes a rework operation, the rework operation is also a target of process mining, and becomes an obstacle in performing process mining. The rework operation is, for example, an operation to the same operation position in the same page among a series of operations to the computer (refer to FIG. 2).

In order to detect the rework operation, for example, the operation log processing device divides the operation log into page units, and then detects a duplicated operation (=rework operation) in the page. In addition, the operation log processing device specifies or removes the detected rework operation.

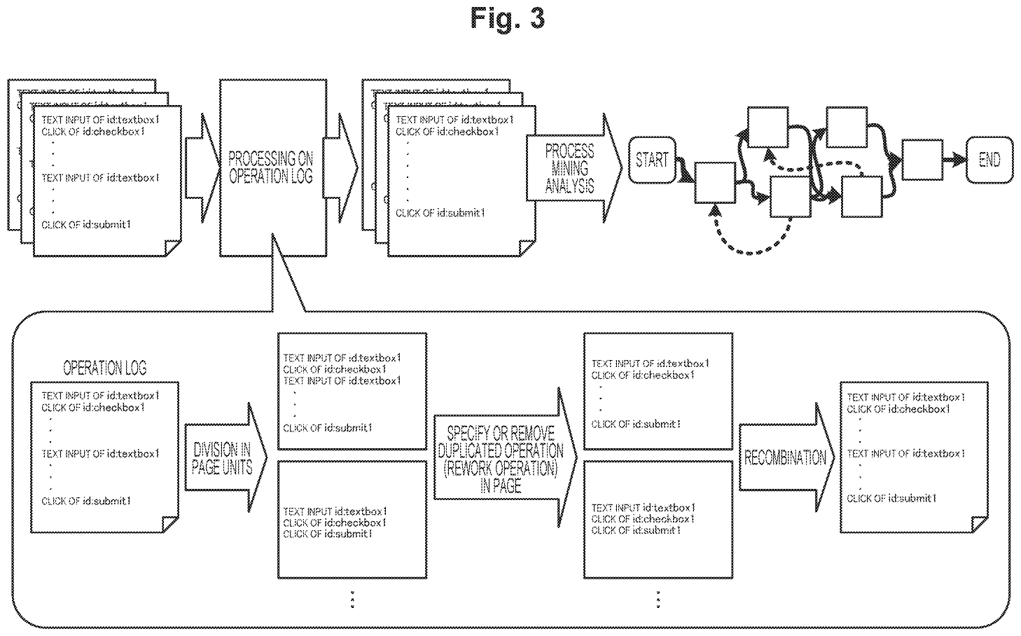

For example, as illustrated in FIG. 3, the operation log processing device divides the operation log into page units, and then detects a duplicated operation (=rework operation) in the page. In addition, the operation log processing device specifies or removes the rework operation detected from each page, recombines the rework operation, and performs process mining analysis or the like.

Thereby, the operation log processing device can obtain an analysis result (for example, the flow diagram illustrated in an upper right portion of FIG. 3) in which the rework operation is specified or removed. As a result, the user can efficiently analyze a series of operations to the computer.

### Configuration Example

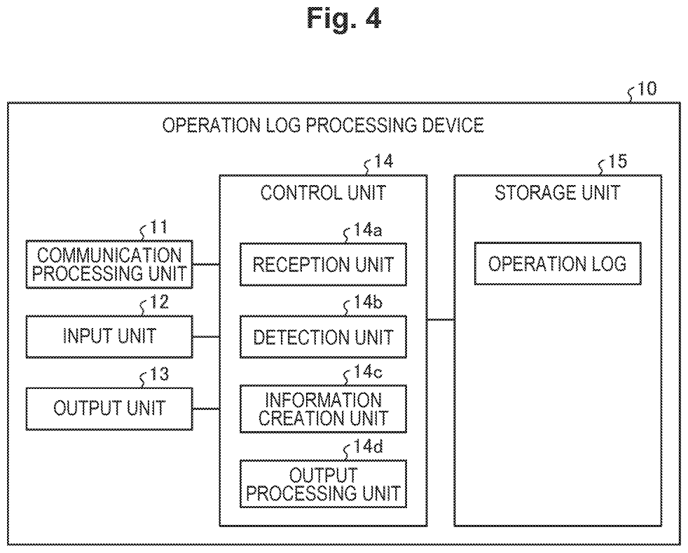

Next, a configuration example of an operation log processing device 10 will be described with reference to FIG. 4. The operation log processing device 10 is implemented by, for example, a general-purpose computer such as a PC. As illustrated in FIG. 4, the operation log processing device 10 includes a communication processing unit 11, an input unit 12, an output unit 13, a control unit 14, and a storage unit 15.

The communication processing unit 11 is implemented by a network interface card (NIC) or the like, and controls communication between an external device and the control unit 14 via a telecommunication line such as a local area network (LAN) or the Internet. For example, the communication processing unit 11 receives an operation log to be processed from the external device.

The input unit 12 is an input interface that receives an input of data from an input device such as a keyboard or a mouse. The output unit 13 is an output interface for outputting data to a display device or the like such as a liquid crystal display.

The storage unit 15 stores data and programs required for various types of processing by the control unit 14. The storage unit 15 stores, for example, an operation log which is input via the input unit 12. The storage unit 15 is implemented by, for example, a semiconductor memory element such as a random access memory (RAM) or a flash memory, or a storage device such as a hard disk or an optical disk.

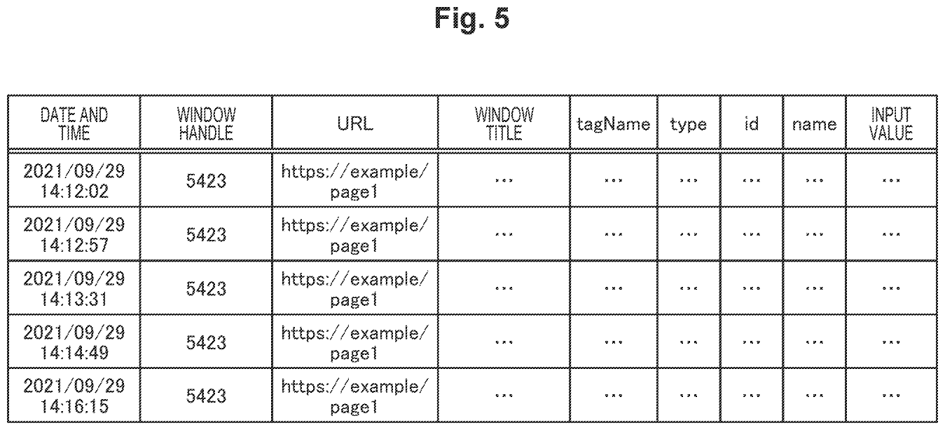

Here, original data of an operation log will be described with reference to FIG. 5. The example of FIG. 5 illustrates an operation log in which operations to a web browser are recorded. For example, as illustrated in FIG. 5, the original data of the operation log includes a date and time when the operation is performed, a window handle, a URL, a window title, a tagName, a type, an id, and a name of a window that is an operation target, and an input value which is input by the operation.

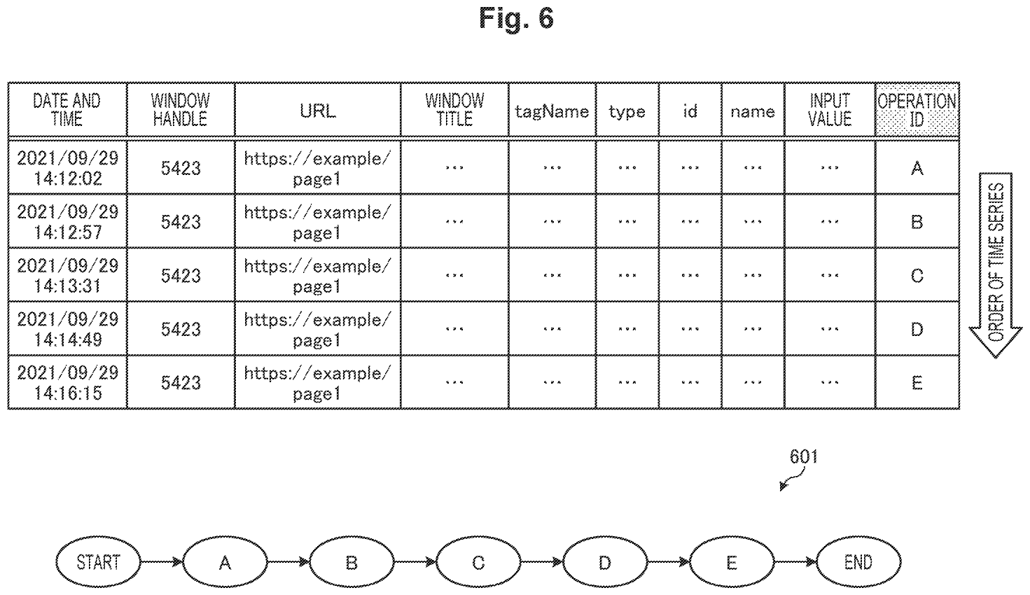

The control unit 14 determines identity of each operation on the original data of the operation log, and assigns an operation ID for identifying each operation to the operation determined to be the same operation (refer to FIG. 6). In a case where the control unit 14 visualizes a series of operations indicated by the operation log illustrated in FIG. 6 in a graph, the series of operations are indicated by a reference numeral 601.

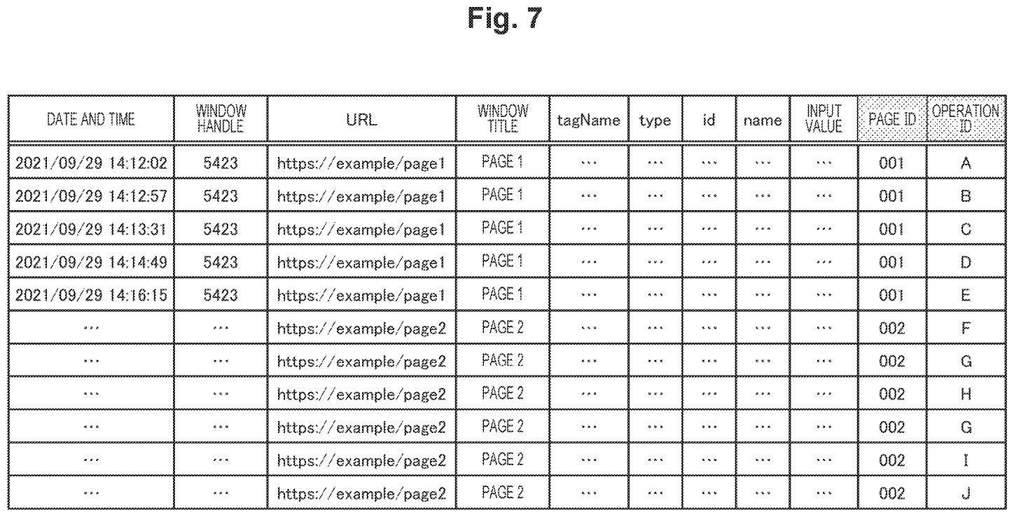

In addition, for example, the control unit 14 determines identity of operation pages on the operation log illustrated in FIG. 6, and assigns a page ID for identifying the same page (refer to FIG. 7). In addition, the control unit 14 stores the operation log to which the operation ID and the page ID are assigned in the storage unit 15.

The control unit 14 includes an internal memory for storing a program defining various processing procedures and the like and required data, and executes various types of processing using the program and the data. For example, the control unit 14 includes a reception unit 14a, a detection unit 14b, an information creation unit 14c, and an output processing unit 14d. Here, the control unit 14 is an electronic circuit such as a central processing unit (CPU) or a micro processing unit (MPU), or an integrated circuit such as an application specific integrated circuit (ASIC) or a field programmable gate array (FPGA).

The reception unit 14a receives an input of an operation log indicating a series of operations to the computer. The detection unit 14b detects an operation log of a rework operation, which is an operation log to the same operation position on the same page, from the operation log.

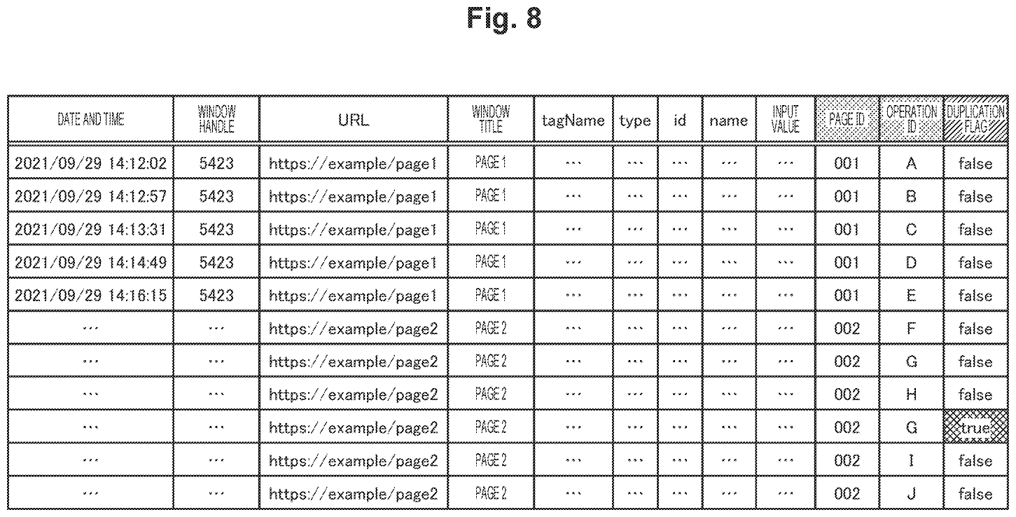

For example, as illustrated in FIG. 8, in a case where the detection unit 14b detects an operation log (=an operation log of a rework operation) to the same operation position on the same page among the operation logs indicating a series of operations to the computer, the detection unit 14b sets a duplication flag (true) in the operation log.

As illustrated in FIG. 8, the detection unit 14b may set a first operation among the duplicated operations as a main operation, and set the duplication flag (true) in the operation logs of the remaining operations. Alternatively, the detection unit 14b may set a last operation among the duplicated operations as a main operation, and set the duplication flag (true) in the operation logs of the remaining operations.

The description returns to FIG. 4. The information creation unit 14c specifies or removes the operation log of the rework operation that is detected by the detection unit 14b from the operation logs received by the reception unit 14a, and creates information visualizing a process of a series of operations to the computer.

For example, the information creation unit 14c performs processing of displaying the operation log of the rework operation detected by the detection unit 14b to identify the operation log from other operation logs among the operation logs received by the reception unit 14a or processing of removing the operation log of the rework operation, and creates information visualizing a process of a series of operations.

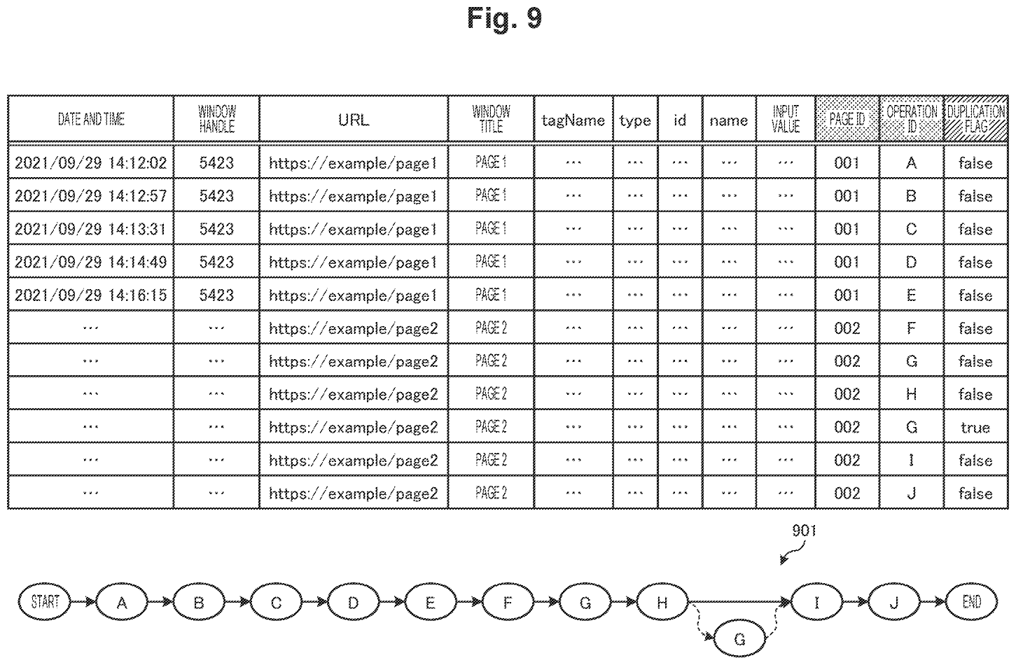

An example will be given. Here, a case where the information creation unit 14c creates information visualizing a process of a series of operations indicated by the operation log illustrated in FIG. 9 will be described as an example. The rework operation is an operation with the operation ID “G”.

Here, in a case where the information creation unit 14c specifies the operation log of the rework operation, as indicated by a reference numeral 901 in FIG. 9, a graph visualizing a series of operations (A→B→C→D . . . ) is created based on the date and time information of the operation log. At this time, the information creation unit 14c expresses an edge connected to a node of the operation with “G” detected as the rework operation to distinguish the edge from normal edges (for example, a broken line arrow illustrated in FIG. 9). In addition, the information creation unit 14c connects an edge (H→I) that bypasses the node of the operation with “G” with normal edges.

The information creation unit 14c creates a graph visualizing a series of operations indicated by the operation log as described above. Thus, the user can easily find which operation is the rework operation among the series of operations. Thereby, the user can easily delete the node and the edge of the rework operation as necessary.

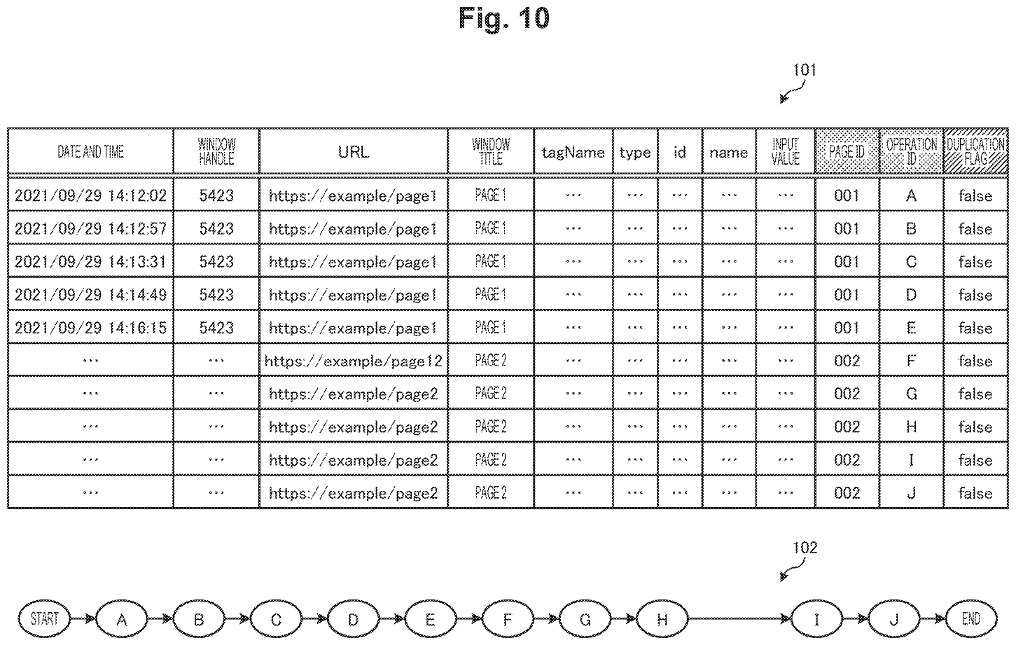

In addition, in a case of deleting the operation log of the rework operation, the information creation unit 14c deletes the operation log of the rework operation from the operation logs illustrated in FIG. 9 (refer to a reference numeral 101 in FIG. 10). Further, the information creation unit 14c creates a graph visualizing a series of operations (A→B→C→D . . . ) based on the date and time information of the operation log after deletion of the operation log of the rework operation (refer to a reference numeral 102 in FIG. 10).

In addition, the information creation unit 14c may create a graph in which processes of a plurality of operations are aggregated by aggregating the same nodes and aggregating edges between the same nodes on each graph visualizing a process of a series of operations.

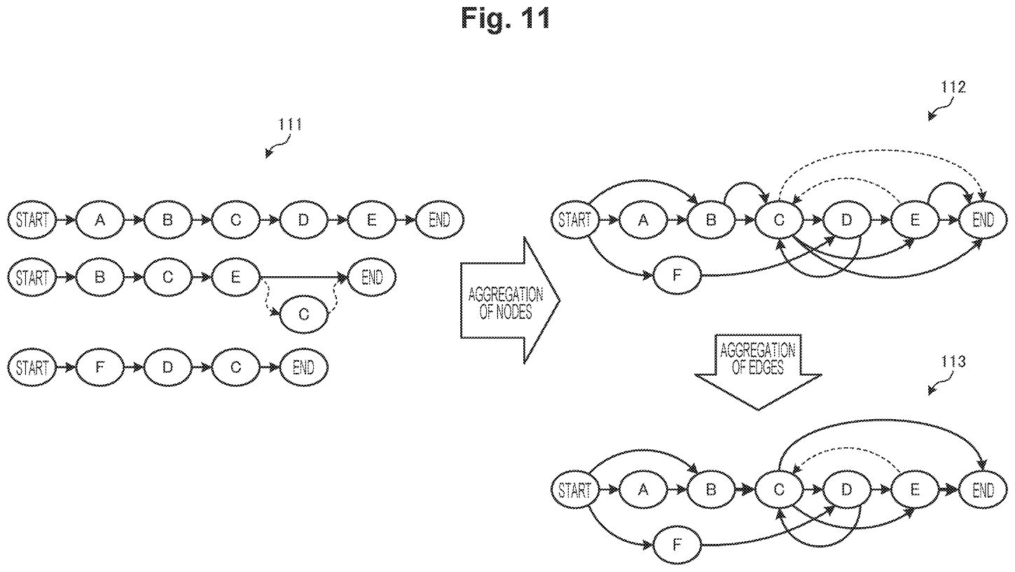

First, a case where the information creation unit 14c aggregates graphs of processes of a plurality of operations including the rework operation will be described. Here, a case where the information creation unit 14c aggregates graphs (refer to a reference numeral 111 in FIG. 11) of processes of three operations including the rework operation will be described as an example.

Rules in aggregation of graphs of processes of operations are as follows.
In a case where a special edge (an edge related to the rework operation) and a normal edge exist in a path between the same nodes, the information creation unit 14c deletes the special edge.
In a case where only a special edge exists in a path between the same nodes, the information creation unit 14c leaves the special edge.
In a case where a plurality of normal edges exist in a path between the same nodes, the information creation unit 14c aggregates the plurality of normal edges into one normal edge. At this time, the information creation unit 14c may thicken the edge according to the number of aggregated normal edges. Further, in addition to thickening the edge, the information creation unit 14c may use another expression such as changing colors according to the number of aggregated normal edges.
In a case where a plurality of special edges exist in a path between the same nodes, the information creation unit 14c aggregates the plurality of special edges into one special edge. At this time, the information creation unit 14c does not thicken the special edge according to the number of aggregated special edges. Here, the special edge may be thickened as necessary. Further, in addition to thickening the edge, the information creation unit 14c may use another expression such as changing colors according to the number of aggregated special edges.

Based on the above rules, the information creation unit 14c aggregates the nodes of the graphs of the processes of the three operations indicated by the reference numeral 111 in FIG. 11, and creates a graph indicated by a reference numeral 112. Thereafter, the information creation unit 14c aggregates the edges of the graph indicated by the reference numeral 112, and creates a graph indicated by a reference numeral 113.

As described above, when aggregating processes of a plurality of operations, in a case where a plurality of edges indicating normal operations exist between the same nodes, the information creation unit 14c changes display of the edges indicating normal operations between the same nodes according to the number of the edges. Here, in a case where a plurality of edges indicating the rework operation exist between the same nodes, the information creation unit 14c changes display of the edges according to a rule different from the rule for changing the display of the edge indicating the normal operation.

In this way, the information creation unit 14c can distinguish edges related to the rework operation, and aggregate the graphs of the processes of the plurality of operations.

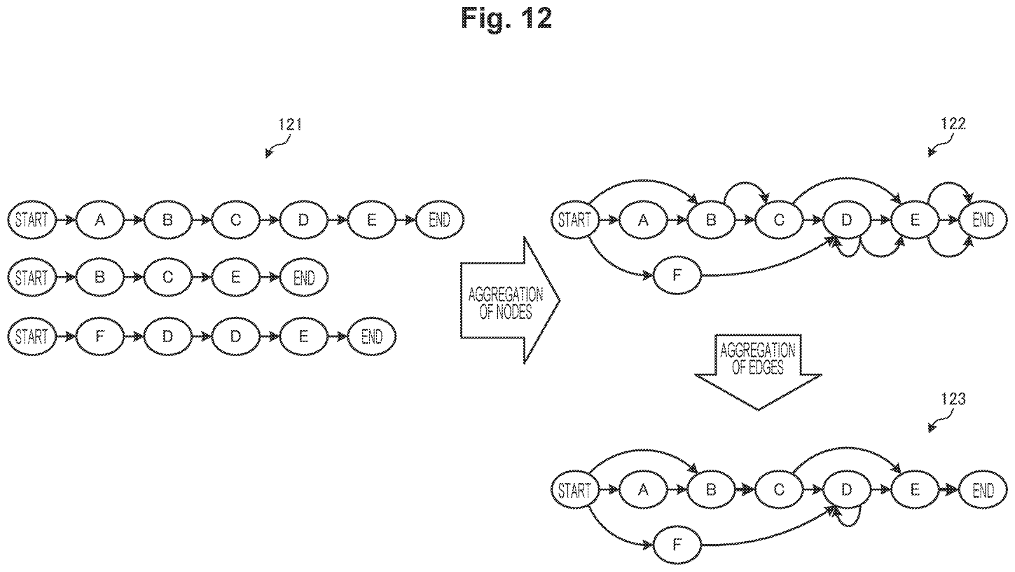

In a case where the information creation unit 14c aggregates the graphs (refer to a reference numeral 121 in FIG. 12) of the processes of the plurality of operations from which the rework operation is deleted, the information creation unit 14c aggregates the nodes (refer to a reference numeral 122) and the edges (refer to a reference numeral 123) in the same manner as in the related art.

The description returns to FIG. 4. The output processing unit 14d outputs the information created by the information creation unit 14c via the output unit 13.

For example, in a case where the information creation unit 14c creates, for the process of a series of operations to the computer, information (refer to the reference numeral 113 in FIG. 11) specifying the rework operation, the output processing unit 14d outputs the information. Further, for example, in a case where the information creation unit 14c creates, for the process of a series of operations to the computer, information (refer to the reference numeral 123 in FIG. 11) from which the rework operation is deleted, the output processing unit 14d outputs the information.

According to such an operation log processing device 10, in a case of creating information visualizing a process of a series of operations, it is possible to create information (for example, the graph indicated by the reference numeral 113 in FIG. 11 or the graph indicated by the reference numeral 123 in FIG. 12) in which the rework operation is specified or removed. As a result, the user can efficiently perform process mining of a series of operations to the computer.

### Example of Processing Procedure

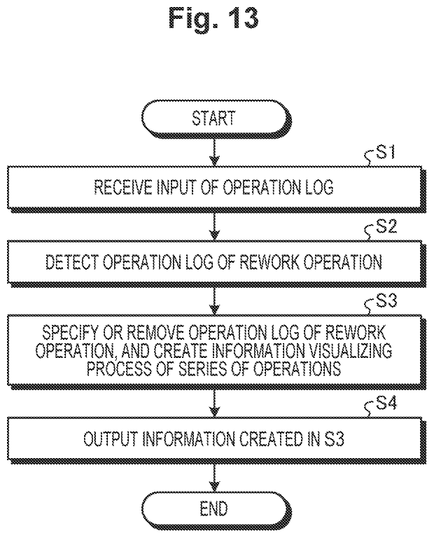

Next, an example of a processing procedure executed by the operation log processing device 10 will be described with reference to FIG. 13. First, the reception unit 14a of the operation log processing device 10 receives an input of an operation log to be processed (S1). Thereafter, the detection unit 14b detects an operation log of a rework operation, which is an operation log to the same operation position, from the operation logs received in S1 (S2).

Next, the information creation unit 14c specifies or removes the operation log of the rework operation that is detected in S2 from the operation logs received in S1, and creates information visualizing a process of a series of operations (S3). Thereafter, the output processing unit 14d outputs the information created in S3 (S4).

### Other Embodiments

For example, in a case of deleting an operation log (a log of a rework operation) to the same operation position on the same page from the operation logs indicating a series of operations to the computer that are illustrated in FIG. 8, the operation log processing device 10 may insert a last operation log in time series among operation logs of duplicated operations into a position of a first operation log, and delete other operation logs.

For example, the operation log processing device 10 inserts a ninth-line operation log with an operation ID “G” among the operation logs illustrated in FIG. 8 into a position of a seventh-line operation log with an operation ID “G”, and deletes the operation log with an operation ID “G” that is on the seventh line so far. In addition, the operation log processing device 10 creates, for the operation log after deletion, information visualizing a process of a series of operations.

### System Configuration and the Like

In addition, each component of each unit illustrated is functionally conceptual, and does not necessarily need to be physically configured as illustrated. That is, specific forms of distribution and integration of devices are not limited to the illustrated forms, and some or all of the devices can be functionally or physically distributed and integrated in any units according to various loads, usage conditions, and the like. Further, all or any part of each processing function performed in each device can be implemented by a CPU and a program executed by the CPU, or can be implemented as hardware by wired logic.

In addition, among the processing described in the above embodiment, all or a part of processing described as being automatically performed may be manually performed, or all or a part of processing described as being manually performed may be automatically performed by a known method. Additionally, the processing procedures, the control procedures, the specific names, and the information including various data and parameters illustrated in the specification and the drawings can be arbitrarily changed unless otherwise specified.

### Program

The operation log processing device 10 can be implemented by installing a program (operation log processing program) as package software or online software in a desired computer. For example, by causing an information processing device to execute the above program, the information processing device can be caused to function as the operation log processing device 10. Here, the information processing device also includes mobile communication terminals such as a smartphone, a mobile phone, and a personal handyphone system (PHS) and terminals such as a personal digital assistant (PDA).

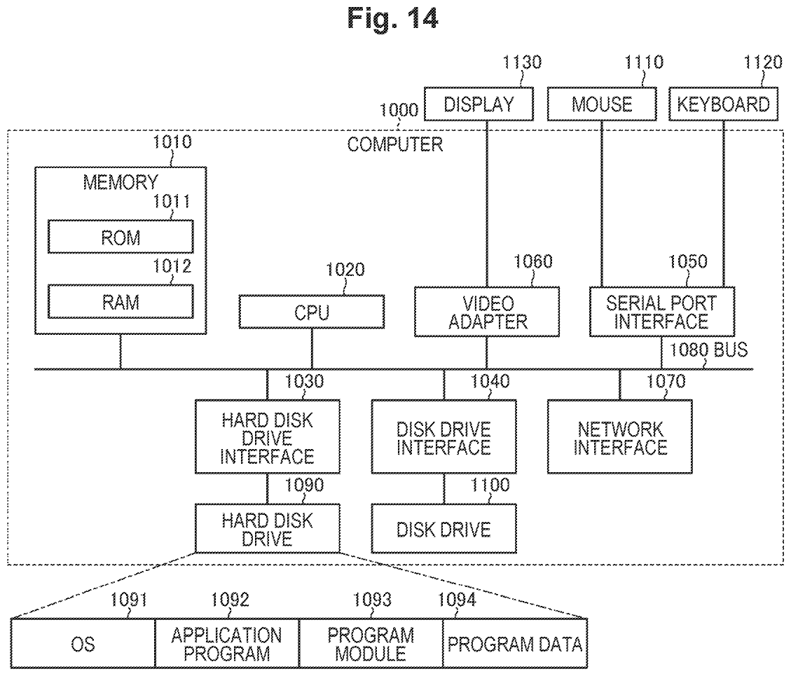

FIG. 14 is a diagram illustrating an example of a computer that executes an operation log processing program. A computer 1000 includes, for example, a memory 1010 and a CPU 1020. In addition, the computer 1000 also includes a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program that defines each processing executed by the operation log processing device 10 is implemented as a program module 1093 in which a code executable by a computer is described. The program module 1093 is stored in, for example, the hard disk drive 1090. For example, the program module 1093 for executing processing similar to the functional configuration in the operation log processing device 10 is stored in the hard disk drive 1090. Note that the hard disk drive 1090 may be replaced with a solid state drive (SSD).

In addition, data used in the processing of the above-described embodiment is stored, for example, in the memory 1010 or the hard disk drive 1090 as the program data 1094. In addition, the CPU 1020 reads the program module 1093 and the program data 1094 stored in the memory 1010 or the hard disk drive 1090 into the RAM 1012 as necessary and executes the program module 1093 and the program data 1094.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). In addition, the program module 1093 and the program data 1094 may be read by the CPU 1020 from another computer via the network interface 1070.

### REFERENCE SIGNS LIST

10 Operation log processing device
11 Communication processing unit
12 Input unit
13 Output unit
14 Control unit
14a Reception unit
14b Detection unit
14c Information creation unit
14d Output processing unit
15 Storage unit

1. An operation log processing device comprising one or more processors configured to perform operations comprising:
receiving an input of an operation log indicating a series of operations to a computer;
detecting an operation log of a rework operation from operation logs indicating the series of operations; and
displaying the detected operation log of the rework operation among the operation logs indicating the series of operations to distinguish the detected operation log from other operation logs or removes the operation log of the rework operation, and creating information visualizing a process of the series of operations.

2. The operation log processing device according to claim 1, wherein
the information visualizing the process of the series of operations is a graph representing the process of the series of operations by nodes and edges.

3. The operation log processing device according to claim 2, wherein the operations comprise:
creating a graph in which processes of a plurality of operations are aggregated by aggregating the same nodes and aggregating edges between the same nodes on each graph visualizing the processes of the series of operations.

4. The operation log processing device according to claim 3, wherein the operations comprise:
when aggregating the processes of the plurality of operations, in a case where only an edge indicating a rework operation exists between the same nodes, leaving the edge, and
in a case where an edge indicating a rework operation and an edge indicating a normal operation exist between the same nodes, deleting the edge indicating the rework operation.

5. The operation log processing device according to claim 4, wherein
when aggregating the processes of the plurality of operations,
in a case where a plurality of edges indicating a normal operation exist between the same nodes, changing display of the edges indicating a normal operation between the same nodes according to the number of the edges, and
in a case where a plurality of edges indicating a rework operation exist between the same nodes, changing display of the edges indicating a rework operation between the same nodes according to a rule different from a rule for changing display of the edges indicating the normal operation.

6. An operation log processing method executed by an operation log processing device, the method comprising:
receiving an input of an operation log indicating a series of operations to a computer;
detecting an operation log of a rework operation from operation logs indicating the series of operations; and
displaying the detected operation log of the rework operation among the operation logs indicating the series of operations to distinguish the detected operation log from other operation logs or removing the operation log of the rework operation, and creating information visualizing a process of the series of operations.

7. A non-transitory computer readable medium storing one or more instructions causing a computer to execute:
receiving an input of an operation log indicating a series of operations to a computer;
detecting an operation log of a rework operation from operation logs indicating the series of operations; and
displaying the detected operation log of the rework operation among the operation logs indicating the series of operations to distinguish the detected operation log from other operation logs or removing the operation log of the rework operation, and creating information visualizing a process of the series of operations.
